(19) United States
(12) Patent Application Publication
(10) Pub. No.: US 2005/0135085 A1
(43) Pub. Date: Jun. 23, 2005

(54) Key-retainer with projection light

(76) Inventor: Jing En Cui, Sanshui City (CN)

Correspondence Address: RABIN & BERDO, P.C.;Suite 500, 1101 14th Street, N.W., Washington, DC, 20005, US

(21) Appl. No.: 10/937,610

(22) Filed: Sep. 10, 2004

(30) Foreign Application Priority Data
Dec. 18, 2003 (CN) 200320119348.X

(51) Int. Cl. F21L 4/00; G09F 13/00

(52) U.S. Cl. 362/116; 362/208; 40/555

(57) ABSTRACT

A key-retainer with projection light includes key-ring, buckle and pendant hanging together each other; said pendant has a case and connecter, one end of said connecter is hanged together with said key-ring and buckle, another end is connected dismountable with the front end of said case, a lens is set on the rear end of the case; the battery, button and lighter which constitutes the circuit is mounted on the front end in the case in this order, said button is located on the case sidewall and a diaphragm printed with figure & character is set between said lighter and lens. When the button is pressed down, said lighter emits light, the pattern characters on the diaphragm printed with figure & character are projected out through the lens and exert an advertisement influence on masses. The present invention could draw more attentions with better advertisement effects.

### TECHNOLOGY FIELD

The present invention relates to a key-retainer, especially relates to a key-retainer with pendant presenting adv effect.

### BACKGROUND TECHNOLOGY

It's usually a practice in the current key-retainer with pendant presenting adv effect that some figure & character and trademark are printed onto the pendant to exert an adv effect. But due to the smaller the pendant is, the printed figure & character and trademark is not outstanding, thus they could not raise the key-retainer's adv effect. The printed figure & character and trademark, however, didn't be rendered light service and thus draw little attention.

### DISCLOSURE OF THE INVENTION

The present invention is proposed to supply a key-retainer with projection light to turn out a better adv effect.

The present invention is realized by the following technology:

The present invention supplies a key-retainer with projection light, including key-ring, buckle and pendant hanging together each other; said pendant has a case and connecter, one end of said connecter is hanged together with said key-ring and buckle, another end is connected dismountable with the front end of said case, a lens is set on the rear end of case; the battery, button and lighter which constitutes the circuit is mounted on front end in the case in this order, said button is located on the case sidewall and a diaphragm printed with figure & character is set between said lighter and lens. When the button is pressed down, said lighter emits light, the pattern characters on the diaphragm printed with figure & character are projected out through the lens and exert an advertisement influence on masses.

For easy mount and application, said lighter in the present invention is a LED. There is a mounting tube on the rear end of said case, the case and mounting tube are dismountable connected; said lens is set on the rear end of the mounting tube by a clip ring; said diaphragm printed with figure & character is set on the front end of the mounting tube by a clamp, the clamp and mounting tube are dismountable connected.

Said dismountable connection in the present invention is screw connection for easy installation between connecter and case, mounting tube and case, or clamp and mounting tube.

The present invention presents following effects: The adv effect in the present invention is realized by the projection produced from the lighter, the lens and the diaphragm printed with figure & character in the pendant case to draw more attentions with better advertisement effects.

### DESCRIPTION OF THE FIGS

The following embodiments and Figures are cited to give a further detailed description of the present invention.

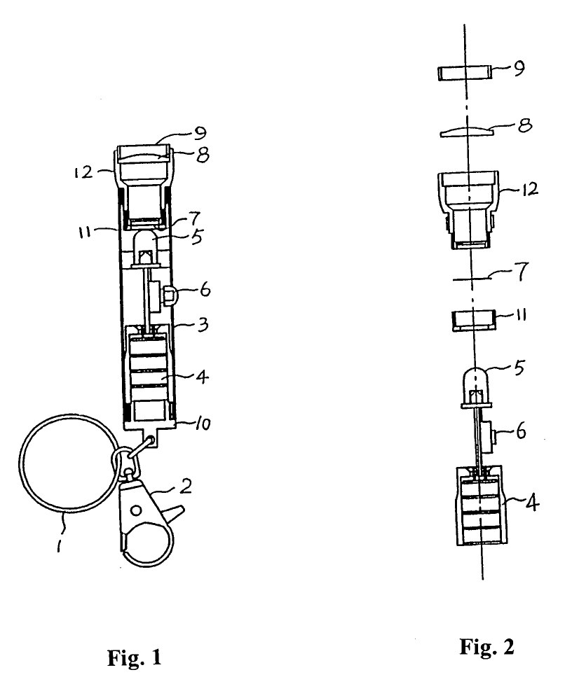

FIG. 1 is a construction illustrative view showing the embodiment of the present invention;

FIG. 2 is an installation illustrative view showing the lighting part in the embodiment of the present invention;

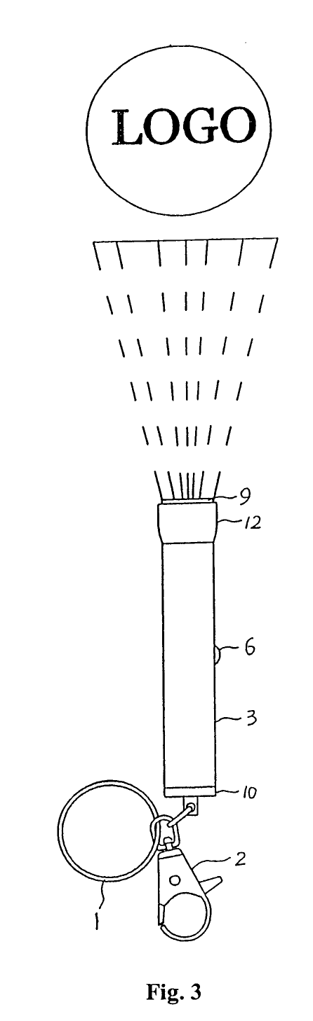

FIG. 3 is an illustrative view showing the application state in the embodiment of the present invention.

### CONCRETE EMBODIMENTS OF THE INVENTION

FIG. 1˜FIG. 3 show the embodiments of the present invention, including key-ring 1, buckle 2 and pendant, the pendant includes case 3, battery 4, LED 5, button 6, diaphragm 7 printed with figure & character, lens 8, clip ring 9 and connecter 10. Refer to FIG. 1, key-ring 1, buckle 2 and one end of pendant connecter 10 are connected each other, the another end of pendant connecter 10 is connected with the front end of case 3 by screw; diaphragm 7 printed with figure & character is a diaphragm printed with “LOGO” (refer to FIG. 3). Refer to FIG. 1 and FIG. 2, battery 4, button 6 and LED 5 which constitutes the circuit is mounted on the front end in the case 3 in this order, button 6 is located on the case 3 sidewall; there is a mounting tube 12 on the rear end of case 3, the case and mounting tube are screw connected, the lens 8 is set on the rear end of mounting tube 12 by a clip ring 9; the “LOGO” diaphragm 7 between LED 5 and lens 8 is set on the front end of mounting sleeve 12 by clamp 11, clamp 11 and mounting sleeve 12 are screw connected. The LED 5 projects the “LOGO” out through “LOGO” diaphragm 7 and lens 8 in turn.

In application, press the button 6 down and the beam from LED 5 projects the “LOGO” character on the “LOGO” diaphragm 7 out through lens 8 to get the image as FIG. 3. In time of part dismounting or changing, the connecter 10 may be dismounted from case 3, mounting tube 12 is dismounted from case 3, or clamp 11 is dismounted from mounting tube 12. Various images with different pattern characters are obtained by changing different diaphragm 7.

1. A key-retainer with projection light, including key-ring, buckle and pendant hanging together each other; characterized in that said pendant has a case and connecter, one end of said connecter is hanged together with said key-ring and buckle, another end is connected dismountable with the front end of said case, a lens is set on the rear end of said case; the battery, button and lighter which constitutes the circuit is mounted on the front end in the case in this order, said button is located on the case sidewall and a diaphragm printed with figure & character is set between said lighter and lens.

2. The key-retainer with projection light according to claim 1, characterized in that said lighter is a LED.

3. The key-retainer with projection light according to claim 1, characterized in that there is a mounting tube on the rear end of said case, the case and mounting tube are dismountable connected; said lens is set on the rear end of the mounting tube by a clip ring; said diaphragm printed with figure & character is set on the front end of the mounting tube by a clamp, the clamp and mounting tube are dismountable connected.

4. The key-retainer with projection light according to claim 1, characterized in that said dismountable connection is screw connection.

5. The key-retainer with projection light according to claim 3, characterized in that said dismountable connection is screw connection.
